(19) United States
(12) Patent Application Publication
(10) Pub. No.: US 2025/0178326 A1
(43) Pub. Date: Jun. 5, 2025

(54) CARRIER FILM, BONDING METHOD, AND FOLDED OPTICAL PATH LENS

(71) Applicants: BEIJING ZITIAO NETWORK TECHNOLOGY CO., LTD., Beijing (CN); LEMON INC., Grand Cayman (KY)

(72) Inventors: Jian CHEN, Beijing (CN); Ziyang ZHANG, Los Angeles, CA (US); Shaopeng ZHU, Beijing (CN); Hsin-Yi HU, Beijing (CN); Wenbin BAI, Beijing (CN)

(21) Appl. No.: 18/968,961

(22) Filed: Dec. 4, 2024

(30) Foreign Application Priority Data
Dec. 4, 2023 (CN) 202311649373.7

(51) Int. Cl. B32B 27/28; B32B 38/00

(52) U.S. Cl. CPC B32B 27/28; B32B 38/0036; B32B 2307/412; B32B 2307/538; B32B 2307/54; B32B 2307/7376; B32B 2551/00

(57) ABSTRACT

The present application provides a carrier film, a bonding method and a folded light path lens. The carrier film includes a substrate, an adhesion-reducing adhesive layer and a release protective film which are sequentially stacked, wherein a light transmittance of a composite layer of the substrate and the adhesion-reducing adhesive layer is greater than or equal to 90%, the carrier film is bonded with a target optical structure at a bonding temperature, and the composite layer is softened at the bonding temperature.

### CROSS REFERENCE TO RELATED APPLICATION

This application claims priority from Chinese Patent Application No. 202311649373.7, filed on Dec. 4, 2023, the contents of which are hereby incorporated by reference in their entirety for all purposes.

### TECHNICAL FIELD

The present application relates to the technical field of materials, in particular to a carrier film, a bonding method and a folded light path lens.

### BACKGROUND

Among various optical devices, an optical function film is an essential component. Generally, the optical function film is bonded to the surface of a lens to realize a specific function, and the lens can be divided into two types, i.e, a plane surface type and a curved surface type, so that the bonding of the optical function film also includes two technological processes, i.e., a flat bonding and a curved bonding. Compared with the flat bonding, the curved bonding process of the film is more complex, but the curved bonding of the film can increase the optical design space, especially in the VR field. The curved bonding of the reflective polarization film (RP film) can enable the reflective surface of the RP film to present a curved surface, and the cooperation of the two curved reflective surfaces can realize the better optical performance of the Pancake (folded light path) lens set. At the process of curved bonding, in order to prevent the function film from scraping and wearing, a layer of carrier film (CF) needs to be bonded on the outside of optical function film, that is, the higher temperature softens the film, with the help of an external fixture, the gripping force generated by the adhesive layer of the carrier film is used to shape the optical function film into a curved surface, and then the bonding with the lens is completed. After bonding, the carrier film is removed to obtain a lens with the optical function film curved bonding thereto.

In the process of bonding the optical function film to the lens, due to the particularity of the optical path, if the optical characteristics (such as reflection, polarization and the like) of the optical function film are to be fully exerted, the alignment of the optical axis angles between the multilayer optical function films needs to be completed before use. For example, in the pancake lens configuration, the slow axis of the wavelength phase retardation film (QWP) and the transmission axis of the reflective polarizing film (RP) need to precisely form an angle of 45°, the transmission axes of the RP and LP (Linear polarizing film) need to be precisely coincident with each other. Otherwise, display problems such as stray light, ghost shadow and the like may occur.

The method for bonding the optical function film to the lens generally includes the following two methods:

The first method includes the following steps: marking the surface of an optical function film in advance, wherein the marks include but are not limited to points, straight lines, right angles and the like, then using a CCD (charge coupled device) to capture the mark points so as to obtain the angle information of the optical axis of the optical function film, then rotating a rotating machine according to the current angle information so as to ensure that the angle between the optical axes of the optical function films reaches a preset value, and then performing a bonding action, namely visual identification alignment bonding (the bonding process can be called as CCD alignment bonding). The CCD alignment bonding is an indirect bonding method, and for an optical function composite film, each layer of film in the optical function composite film needs to be detected in advance for its optical axis, so that time and labor are wasted; in addition, the requirement on the uniformity of the optical axis of the optical function film is high, otherwise, the accuracy of the final alignment angle cannot be guaranteed by the detection of the local optical axis of the optical function film, and the display problems of stray light, ghost shadow and the like finally occur.

The second method includes the following steps: passing a beam of polarized light through an optical function film to be aligned and entering a receiver, obtaining the angular relation among various films through detection of partial characteristics (information such as intensity and phase) of the polarized light, carrying out rotation correction through a rotating machine, and then carrying out bonding action, namely polarized optical alignment (the bonding process can be called as AA (Active Alignment) bonding). The AA bonding is a direct bonding method, can ensure that the alignment between optical function film is more accurate, the introduced process steps are less, and the requirement on the uniformity of the optical axis of the optical function film is relatively low.

In the two bonding methods, the AA bonding has irreplaceable advantages, but since the carrier film is in the polarization light path, the carrier film should not have interference on the polarization light path, and meanwhile the carrier film should have the plasticity to form curved surface with the optical function film, such that the bonding with the lens can be achieved. However, it is difficult for the conventional carrier film to satisfy the above requirements at the same time.

### SUMMARY

In one aspect of the present application, a carrier film is provided. According to an embodiment of the present application, the carrier film includes a substrate, an adhesion-reducing adhesive layer and a release protective film which are sequentially stacked, wherein a light transmittance of a composite layer of the substrate and the adhesion-reducing adhesive layer is greater than or equal to 90%, the carrier film is bonded with a target optical structure at a bonding temperature, and the composite layer is softened at the bonding temperature.

According to an embodiment of the present application, the substrate satisfies at least one of the following conditions: a thickness of the substrate is 30-150 micrometers, and a deviation of the thicknesses at different positions is less than or equal to 5%; a surface roughness Ra of the substrate is less than or equal to 0.5 micrometer; a surface tension of the substrate is greater than or equal to 50 mN/m.

According to an embodiment of the present application, an elongation at break of the substrate is greater than or equal to 10% at the bonding temperature.

According to an embodiment of the present application, the substrate further satisfies at least one of the following conditions: a softening temperature of the substrate is greater than or equal to a preset temperature, and the preset temperature is the bonding temperature minus 30° C.; and a shape and a color of the substrate do not change when the substrate is processed at the bonding temperature for a preset time.

According to an embodiment of the present application, the substrate further satisfies at least one of the following conditions: a light transmittance of the substrate is greater than or equal to 90%; a haze of the substrate is less than or equal to 1%; an in-plane phase retardation RO of the substrate is less than or equal to 10 nm.

According to an embodiment of the present application, the substrate includes at least one of Polymethyl Methacrylate, Polycarbonate, Triacetyl Cellulose, Cyclic Olefin Polymer, Cyclic Olefin Copolymer, Polyester, Polypropylene, Polyethylene, Polyolefin, Polyimide, Thermoplastic Polyurethane, and Polyvinyl Chloride.

According to an embodiment of the present application, the adhesion-reducing adhesive layer satisfies at least one of the following conditions: a thickness of the adhesion-reducing adhesive layer is 0.1-20 micrometers, and a deviation of the thicknesses at different positions is less than or equal to 5%; the adhesion-reducing adhesive layer includes at least one of acrylic adhesive, epoxy adhesive, organic silicon adhesive and polyurethane adhesive; a coating method for forming the adhesion-reducing adhesive layer includes at least one of slot die coating, micro-gravure coating and comma coating.

According to an embodiment of the present application, the adhesion-reducing adhesive layer further satisfies at least one of the following conditions: a peeling force between the adhesion-reducing adhesive layer and the adhered film layer before adhesion-reducing is greater than or equal to 1000 gf/cm²; the peeling force between the adhesion-reducing adhesive layer and the adhered film layer after adhesion-reducing is less than or equal to 100 gf/cm².

According to an embodiment of the present application, the adhesion-reducing adhesive layer is a UV adhesion-reducing adhesive layer, and the UV adhesion-reducing adhesive layer satisfies at least one of the following conditions: a wavelength of an UV light is 365 nm-410 nm; a light intensity density received by an adhesive surface of the UV adhesion-reducing adhesive layer is greater than or equal to 2000 mJ/cm².

According to an embodiment of the present application, the UV adhesion-reducing adhesive layer further satisfies at least one of the following conditions: the UV adhesion-reducing adhesive layer has the tolerance time of not less than 3 minutes at the bonding temperature; when a thickness of the UV adhesion-reducing adhesive layer is 100 micrometers, a light transmittance of the UV adhesion-reducing adhesive layer is greater than or equal to 90%, and a haze of the UV adhesion-reducing adhesive layer is less than or equal to 1%.

According to an embodiment of the present application, the release protective film satisfies at least one of the following conditions: a thickness of the release protective film is 5-100 micrometers; a surface roughness Ra of the release protective film is less than or equal to 0.5 micrometer; a residual adhesion rate of the release protective film is greater than or equal to 90%; a peeling force between the release protective film and the adhesion-reducing adhesive layer is less than or equal to 200 gf/cm².

In another aspect of the present application, a bonding method is provided. According to an embodiment of the present application, the bonding method includes: providing a first carrier film, wherein the first carrier film is the above described carrier film, and removing the release protective film of the first carrier film; providing a first optical function layer, wherein the first optical function layer includes a first function layer body and a first adhesive layer which are sequentially stacked; adhering the surface of the adhesion-reducing adhesive layer of the first carrier film to a surface of the first function layer body facing away from the first adhesive layer to obtain a first composite layer body; providing a lens and a bonding socket, wherein the bonding socket includes an upper bonding socket and a lower bonding socket, a profile of the lens is respectively matched with a profile of a bonding surface of the upper bonding socket and a profile of a bonding surface of the lower bonding socket, and placing the lens on the bonding surface of the lower bonding socket; placing the first composite layer body on a side of the lens facing away from the lower bonding socket, wherein the first adhesive layer is arranged close to the lens; heating a temperature to the bonding temperature to soften the first composite layer, bonding the upper bonding socket to the first composite layer and performing pressing-bonding treatment; and removing the bonding socket. According to an embodiment of the present application, the bonding method further includes: providing a second carrier film, wherein the second carrier film is the above-described carrier film, and removing the release protective film of the second carrier film; providing a second optical function layer, wherein the second optical function layer includes a second function layer body and a second adhesive layer which are sequentially stacked; adhering the surface of the adhesion-reducing adhesive layer of the second carrier film to the surface of the second function layer body facing away from the second adhesive layer to obtain a second composite layer body; placing the other surface of the lens on the bonding surface of the lower bonding socket, wherein the substrate of the first carrier film is in contact with the bonding surface of the lower bonding socket; placing the second composite layer body on a side of the lens facing away from the lower bonding socket, wherein the second adhesive layer is arranged close to the lens; heating the temperature to the bonding temperature to soften the second composite layer, bonding the upper bonding socket to the second composite layer, and performing press-bonding treatment; and removing the bonding socket.

According to an embodiment of the present application, the bonding method further includes: respectively carrying out UV light irradiation on a surface of the substrate of the first carrier film and a surface of the substrate of the second carrier film, so that a peeling force of the adhesion-reducing adhesive layer of the first carrier film and a peeling force of the adhesion-reducing adhesive layer of the second carrier film is reduced; and peeling the adhesion-reducing adhesive layer of the first carrier film from the substrate thereof, and peeling the adhesion-reducing adhesive layer of the second carrier film from the substrate thereof.

According to an embodiment of the present application, the first function layer body includes at least one of a wavelength phase retardation film, a reflective polarizing film, and a linear polarizing film, and the second function layer body includes at least one of the wavelength phase retardation film, the reflective polarizing film, and the linear polarizing film.

According to an embodiment of the present application, the bonding temperature is 100-130° C.

In yet another aspect of the present application, the present application provides a folded optical path lens. According to an embodiment of the present application, the folded optical path lens includes a lens and an optical function layer, wherein the optical function layer is bonded to a surface of the lens, and a bonding method is implemented by the bonding method described above.

### BRIEF DESCRIPTION OF THE DRAWINGS

The above and/or additional aspects and advantages of the present application will become apparent and readily appreciated from the following description of the embodiments, taken in conjunction with the accompanying drawings of which:

FIG. 1 is a schematic view of a structure of a carrier film according to an embodiment of the present application;

FIG. 2 is a flow chart showing a structure of a bonding method according to another embodiment of the present application;

FIG. 3 is a schematic view of a structure of a lens bonded to an optical function layer in accordance with yet another embodiment of the present application;

FIG. 4 is a flow chart showing a structure of a bonding method according to yet another embodiment of the present application;

FIG. 5 is a schematic view of a structure of a lens bonded to an optical function layer in accordance with yet another embodiment of the present application;

FIG. 6 is a flow chart of removing the carrier film in yet another embodiment of the present application;

FIG. 7 is a schematic view of a structure of a folded optical path lens according to yet another embodiment of the present application.

### DETAILED DESCRIPTION

The solution of the present application will be explained with reference to the following examples. It will be appreciated by those skilled in the art that the following examples are illustrative of the present application only and should not be taken as limiting the scope of the present application. In case that the examples do not specify particular techniques or conditions, they are performed according to techniques or conditions described in literature in the art or according to the product specification.

It should be note that the present application will now be described with reference to specific examples, which are intended to be illustrative only and not to be limiting in any way.

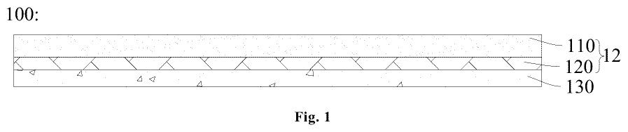

In one aspect of the present application, a carrier film for optical alignment bonding is provided. According to an embodiment of the present application, referring to FIG. 1, the carrier film 100 includes a substrate 110, an adhesion-reducing adhesive layer 120, and a release protective film 130, which are sequentially stacked, wherein a light transmittance of a composite layer 12 of the substrate 110 and the adhesion-reducing adhesive layer 120 is greater than or equal to 90%, the carrier film is bonded to a target optical structure at a bonding temperature, and the composite layer is softened at the bonding temperature. Therefore, the carrier film 100 of the present application does not have interference on the optical path of the target optical structure (such as an optical function layer) bonded thereto, and further does not influence the optical performance of the optical function layer. The carrier film has stable performance in thermal and mechanical aspects and can not be deteriorated, so that the composite layer can be well matched with the profile of the optical component (such as a lens) and well bonded with the optical component at the bonding temperature. Meanwhile, the substrate and the adhesion-reducing adhesive layer will not cause corrosion and other undesirable phenomena to the target optical structure (such as the optical function layer) bonded thereto. The composite layer 12 is softened under the bonding temperature with no change in its shape and color, so that the direct alignment bonding of optical component and optical function layer can be effectively realized, that is, the AA bonding is realized.

It should be note that the bonding temperature is a temperature at which the composite layer body obtained by bonding the carrier film and the optical function layer is bonded to an optical component (for example, a lens). The composite layer 12 does not change in its shape or color at the bonding temperature, wherein the absence of change in shape does not mean that the composite layer 12 is softened, but means that the composite layer is free from defects such as wrinkles and curling; the absence of change in color means that the substrate has no defects such as whitening, blackening, discoloration and the like in a visible range of naked eyes.

According to some embodiments of the present application, in order to obtain a carrier films with better performance, the basic physical properties of the substrate 110 include the following requirements: the thickness of the substrate is 30-150 micrometers (such as 30 micrometers, 40 micrometers, 50 micrometers, 60 micrometers, 70 micrometers, 80 micrometers, 90 micrometers, 100 micrometers, 110 micrometers, 120 micrometers, 130 micrometers, 140 micrometers, 150 micrometers and the like), and a deviation of the thicknesses at different positions is less than or equal to 5%, so that the flatness of the substrate is high, the adhesion between the substrate and the adhesion-reducing adhesive layer can be improved, and the uniformity of the whole thickness of the carrier film is ensured; the surface roughness Ra of the substrate is less than or equal to 0.5 micrometer, for example, the Ra is 0.5 micrometer, 0.45 micrometer, 0.4 micrometer, 0.35 micrometer, 0.3 micrometer, 0.25 micrometer, 0.2 micrometer or 0.1 micrometer, so that the flatness of the substrate is high, and the adhesion between the substrate and the adhesion-reducing adhesive layer can be further improved; the surface tension of the substrate is greater than or equal to 50 mN/m, for example, the surface tension is 50 mN/m, 55 mN/m, 60 mN/m, 65 mN/m, 70 mN/m, 75 mN/m, 80 mN/m, 85 mN/m, 90 mN/m and the like, and the requirements of the surface tension can greatly improve the flatness and the smoothness of the substrate, further improve the adhesive force between the adhesion-reducing adhesive layer and the substrate, improve the integral stability of the carrier film, and improve the adhesive bonding between the carrier film and the target optical structure (such as an optical function layer).

According to some embodiments of the present application, the elongation at break of the substrate at the bonding temperature is greater than or equal to 10%, such as 10%, 12%, 14%, 15%, 17%, 19%, 20%, 22%, 25%, 27%, 29%, 30%, and the like. Therefore, the substrate has appropriate deformability; the overall deformability of the carrier film is improved, and when the carrier film is bonded with the curved lens, the carrier film has high thermoplasticity so as to be matched with the curved surface, so that the carrier film and the curved lens can be well bonded.

According to some embodiments of the present application, the softening temperature of the substrate is greater than or equal to a predetermined temperature, and the predetermined temperature is a bonding temperature minus 30° C. For example, the bonding temperature is 100° C., then the predetermined temperature is 70° C., that is, the softening temperature needs to be greater than or equal to 70° C. During the bonding process, if the softening temperature of the substrate is too low, it will cause the shrinkage and deformation of the carrier film in use, or even the melting and cracking thereof. Further, in some embodiments, the bonding temperature can be 100-130° C., for example, 100° C., 105° C., 110° C., 115° C., 120° C., 125° C., 130° C. and the like. At the above temperature, the composite layer 12 can be softened so as to be bonded with the lens with a curved surface, and the above temperature does not have any adverse effect on each film layer in the composite layer 12, and docs not cause obvious changes in its shape and color, i.e., defects such as wrinkles, curling, whitening, blackening, discoloration, and the like, or any adverse effect on the lens.

In some embodiments of the present application, the shape and color of the substrate do not change when the substrate is baked at the bonding temperature for a predetermined time, wherein the absence of change in shape does not mean that the composite layer 12 is softened, but means that the composite layer is free from defects such as wrinkles and curling; the absence of change in color means that the substrate has no defects such as whitening, blackening, discoloration and the like in a visible range of naked eyes. From this, it can guarantee that the substrate does not have the defects such as wrinkles and curling during the bonding process, the deterioration thereof can be prevented simultaneously, and then guarantee the good bonding between the carrier film and the optical component such as lens. Furthermore, in some embodiments, the predetermined time is 3 minutes, that is, the shape and color of the substrate do not change when the substrate is baked at the bonding temperature for 3 minutes, so that the good bonding between the carrier film and the optical component can be effectively achieved within the above time range.

According to some embodiments of the present application, the light transmittance of the substrate is greater than or equal to 90%, so that the substrate and even the carrier film do not absorb the light desired for operation (such as the polarized light) significantly, and do not substantially affect the optical path of the light (such as polarized light) of the optical function layer, thereby ensuring good light transmission of the optical function layer and the optical component.

In some embodiments of the present disclosure, the haze of the substrate is less than or equal to 1%, such that the substrate does not emit light significantly, thereby ensuring good transmission of light (e.g., the polarized light).

In some embodiments of the present application, the in-plane phase retardation RO of the substrate is less than or equal to 10 nm, so that a lower retardation can ensure that the carrier film can be bonded to the optical function layer at any angle without adversely affecting the alignment effect of subsequent polarized light and other light. In some embodiments, the in-plane retardation of the substrate is less than or equal to 3 nm, so that the substrate has less influence on the propagation of the light, and the deviation of the optical alignment angle can be controlled within 0.5%. When a beam of light passes through a film with birefringence and is divided into o light and e light, the in-plane phase retardation R0=|no−ne|*d, wherein no and ne are refractive indexes of the o light and the e light in the film, and d is the thickness of the film.

According to some embodiments of the present application, the substrate includes at least one of Polymethyl Methacrylate (PMMA), Polycarbonate (PC), Triacetate Cellulose (TCA), Cyclic Olefin Polymer (COP), Cyclic Olefin Copolymer (COC), Polyester (such as PEN, PET, OKP and the like), Polypropylene (PP), Polyethylene (PE), Polyolefin (PO), Polyimide (PI), Thermoplastic Polyurethane (TPU), and Polyvinyl Chloride (PVC). The substrate formed by the material has required good physical properties, thermal properties, mechanical properties and optical properties, meets various requirements of the optical component and the optical function layer on the carrier film, and is beneficial to effectively realizing AA bonding of the optical component and the optical function layer.

According to some embodiments of the present application, the thickness of the adhesion-reducing adhesive layer is 0.1-20 micrometers, and the deviation of the thicknesses at different positions is less than or equal to 5%, so that the adhesion-reducing adhesive layer has high flatness, the adhesion between the substrate and the adhesion-reducing adhesive layer can be improved, the uniformity of the overall thickness of the carrier film can be ensured, and the adhesion effect of the carrier film with the optical function layer and the optical component can be improved.

According to some embodiments of the present application, the adhesion-reducing adhesive layer includes at least one of an acrylic adhesive, an epoxy adhesive, a silicone adhesive and a polyurethane adhesive, and the adhesive layer in the above system has good stability and will not cause corrosion and other undesirable phenomena to the layer structure adhered to the adhesion-reducing adhesive layer. In some embodiments, the adhesion-reducing adhesive layer is an acrylic adhesive, so that the adhesion-reducing adhesive layer has better stability and is more friendly to the layer structure contacted and adhered with the adhesion-reducing adhesive laver.

According to some embodiments of the present application, the coating method to form the adhesion-reducing adhesive layer includes at least one of slot die coating, micro-gravure coating, comma coating. In the present application, various coating methods can be selected, and the forming method is not specially limited, so that the process condition for forming the carrier film is reduced, and the cost is reduced.

According to some embodiments of the present application, the peeling force between the adhesion-reducing adhesive layer and the adhered film layer before adhesion-reducing is greater than or equal to 1000 gf/cm², such as 1000 gf/cm², 1050 gf/cm², 1100 gf/cm², 1150 gf/cm², 1200 gf/cm², 1250/cm², 1300 gf/cm², 1350 gf/cm², 1400 gf/cm², 1450 gf/cm², 1500 gf/cm² and the like, so that the carrier film has good adhesion with the adhered film layer (such as an optical function layer), and the problems of dislocation and the like are not easy to occur in subsequent processes. In some embodiments, the peeling force between the adhesion-reducing adhesive layer and the adhered film layer before adhesion-reducing is equal to or greater than 1500 gf/cm², such as 1500 gf/cm², 1550 gf/cm², 1600 gf/cm², 1650 gf/cm², 1700 gf/cm², 1750 gf/cm², 1800 gf/cm², 1850 gf/cm², 1900 gf/cm², 1950 gf/cm², 2000 gf/cm², and the like.

According to some embodiments of the present application, after adhesion-reducing, the peeling force between the adhesion-reducing adhesive layer and the adhered film layer (e.g., the optical function layer) is less than or equal to 100 gf/cm², such as 100 gf/cm², 95 gf/cm², 90 gf/cm², 85 gf/cm², 80 gf/cm², 75 gf/cm², 70 gf/cm², 65 gf/cm², 60 gf/cm², 55 gf/cm², 50 gf/cm², and the like, so that after adhesion-reducing treatment, the adhesive force between the adhesion-reducing adhesive layer and the adhered film layer is greatly weakened, so that the adhesion-reducing adhesive layer can be easily peeled from the adhered film layer without causing any adverse effects on the adhered film layer. In some embodiments, the peeling force between the adhesion-reducing adhesive layer and the adhered film layer (e.g., the optical function layer) after adhesion-reducing is less than or equal to 50 gf/cm², e.g., 50 gf/cm², 45 gf/cm², 40 gf/cm², 35 gf/cm², 30 gf/cm², 25 gf/cm², 20 gf/cm², 15 gf/cm², 10 gf/cm² and the like.

According to some embodiments of the present application, the adhesion-reducing adhesive layer is a UV (ultraviolet) adhesion-reducing adhesive layer, and the wavelength of the UV light is 365 nm to 410 nm, for example, a mercury lamp, a metal halide lamp, LED lamp or the like may be selected, so that the present application has a wide range of selectivity to the wavelength of UV light, thus reducing the difficulty of adhesion-reducing treatment. In some embodiments, one skilled in the art can also select light sources with wavelengths less than 365 nm or wavelengths greater than 410 nm, as long as the adhesion-reducing can be effectively performed without adversely affecting the adhered film layer and the optical component.

According to some embodiments of the present application, a light intensity density received by an adhesive surface of the UV adhesion-reducing adhesive layer is greater than or equal to 2000 mJ/cm², so that the adhesion-reducing effect can be achieved fast, and the whole layer of UV adhesion-reducing adhesive layer can be subjected to adhesion-reducing treatment, the local adhesion-reducing effect is not poor, and the adhesion-reducing adhesive layer is prevented from being locally torn in the peeling process.

According to some embodiments of the present application, the UV adhesion-reducing adhesive layer can withstand the bonding temperature for not less than 3 minutes, so that the UV adhesion-reducing adhesive layer has better heat resistance, and is not deteriorated and deformed except for being softened (such as wrinkle, curl and the like) at the bonding temperature, thereby ensuring good adhesion and stability, and not affecting the adhesion-reducing effect after UV illumination. It should be note that the resistance time means a time period during which the properties such as tackiness, adhesion-reducing and the like of the UV adhesion-reducing adhesive layer are not affected by the temperature at the bonding temperature, or the properties such as tackiness, adhesion-reducing and the like of the UV adhesion-reducing adhesive layer do not change before and after being at the bonding temperature within the range of the resistance time.

According to some embodiments of the present application, when a thickness of the UV adhesion-reducing adhesive layer is 100 micrometers, a light transmittance of the UV adhesion-reducing adhesive layer is greater than or equal to 90%, and a haze of the UV adhesion-reducing adhesive layer is less than or equal to 1%. Therefore, the UV adhesion-reducing adhesive layer has good light transmittance, and does not have obvious absorption on light that needs to be transmitted.

According to some embodiments of the present application, the thickness of the release protective film is 5-100 micrometers, so that the adhesion-reducing adhesive layer can be well protected, and the overall thickness of the carrier film is not too thick.

According to some embodiments of the present application, the surface roughness Ra of the release protective film is less than or equal to 0.5 micrometer, so that the surface of the release protective film is smooth, the adverse effect on the adhesion of the adhesion-reducing adhesive layer is avoided when the release protective film is torn off, and the release protective film is easy to tear off.

According to some embodiments of the present application, the residual adhesion rate of the release protective film is greater than or equal to 90%, so that the quality of the release protective film is good. The release protective film can use silicon or non-silicon release agent. The test method of the residual adhesion rate can adopt the test method of national standard GB/T25256-2010.

According to some embodiments of the present application, a peeling force between the release protective film and the adhesion-reducing adhesive layer is less than or equal to 200 gf/cm², so that the release protective film can be easily peeled without damaging the performance of the adhesion-reducing adhesive layer. In some embodiments, a peeling force between the release protective film and the adhesion-reducing adhesive layer is less than or equal to 100 gf/cm².

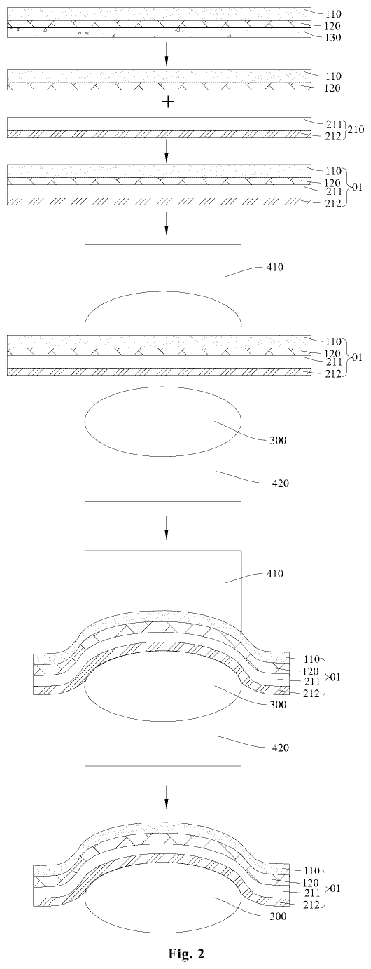

In another aspect of the present application, a bonding method is provided. According to an embodiment of the present application, referring to FIG. 2, the bonding method includes:

S100: providing a first carrier film, wherein the first carrier film is the carrier film 100 described above, and removing the release protective film 130 of the first carrier film (i.e., the carrier film 100);

S200: providing a first optical function layer 210, wherein the first optical function layer 210 includes a first function layer body 211 and a first adhesive layer 212 which are sequentially stacked;

S300: adhering a surface of the adhesion-reducing adhesive layer 120 of the first carrier film to a surface of the first function layer body 211 facing away from the first adhesive layer 212 to obtain a first composite layer body 01;

S400: providing a lens 300 and a bonding socket, wherein the bonding socket includes an upper bonding socket 410 and a lower bonding socket 420, the profile of the lens 300 is respectively matched with the profile of the bonding surface of the upper bonding socket 410 and the profile of the bonding surface of the lower bonding socket 420, and placing the lens 300 on the bonding surface of the lower bonding socket 410;

S500: placing the first composite layer body 01 on the side of the lens 300 facing away from the lower bonding socket 420, wherein the first adhesive layer 212 is arranged close to the lens 300;

In some embodiments, in this step, the first carrier film may be clamped by a fixture to prevent the adhesion-reducing adhesive layer and the substrate in the first carrier film from being dislocated during the press-bonding treatment in the subsequent step. Further, the fixture only clamps the first carrier film and does not clamp the first function layer body, since the deformation amounts of the first carrier film and the first function layer body at the bonding temperature are different, if the fixture simultaneously clamps the first carrier film and the first function layer body, the bonding effect is seriously influenced due to the difference of the deformation amounts of the first carrier film and the first function layer body.

S600: heating the temperature to the bonding temperature to soften the first composite layer body 01, bonding the upper bonding socket 410 to the first composite layer body 01, and performing press-bonding treatment; and

S700: removing the bonding socket.

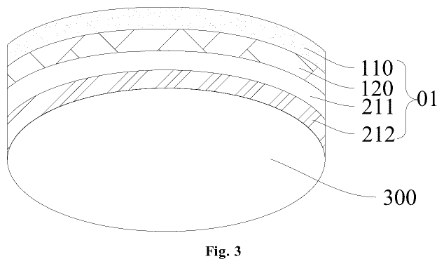

According to some embodiments of the present application, referring to FIG. 3, after completing the bonding of the first composite layer 01, the bonding method of the present application further includes: cutting the first composite layer body 01 according to the size of the lens to obtain the first composite layer body 01 matched with the size of the lens.

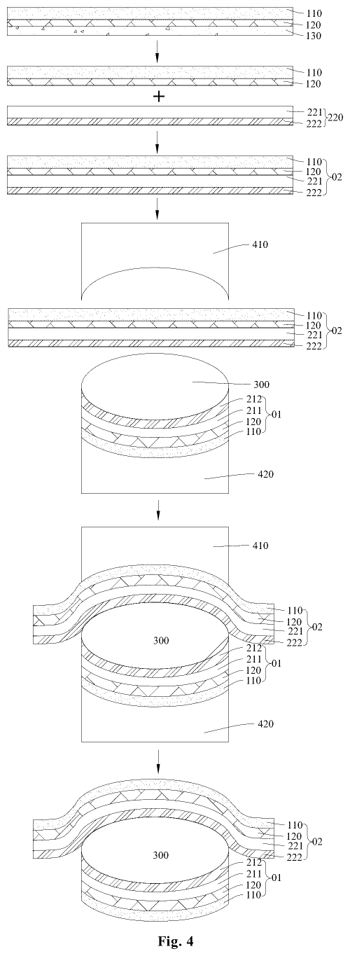

According to some embodiments of the present application, referring to FIG. 4, the bonding method further includes bonding an optical function layer and a carrier film to another surface of the lens, which may specifically include:

T100: providing a second carrier film, wherein the second carrier film is the carrier film 100 described above, and removing the release protective film 130 of the second carrier film (i.e., the carrier film 100);

T200: providing a second optical function layer 220, wherein the second optical function layer 220 includes a second function layer body 221 and a second adhesive layer 222 which are sequentially stacked;

T300: adhering the surface of the adhesion-reducing adhesive layer 120 of the second carrier film to the surface of the second function layer body 221 facing away from the second adhesive layer 222 to obtain a second composite layer 02;

T400: placing the other surface (bonded to the lower surface of the first composite layer 01) of the lens 300 on the bonding surface of the lower bonding socket 420, wherein the substrate 110 (the substrate 110 in the first composite layer 01) of the first carrier film is in contact with the bonding surface of the lower bonding socket 420;

T500: placing the second composite layer 02 on the side of the lens 300 facing away from the lower bonding socket 420, and placing the second adhesive layer 222 close to the lens 300;

In some embodiments, in this step, the second carrier film may be clamped by a fixture to prevent the adhesion-reducing adhesive layer and the substrate in the second carrier film from being dislocated during the press-bonding treatment in the subsequent step. Further, the fixture only clamps the second carrier film and does not clamp the second function layer body, since the deformation amounts of the second carrier film and the second function layer body at the bonding temperature are different, if the fixture simultaneously clamps the second carrier film and the first function layer body, the bonding effect is seriously influenced due to the difference of the deformation amounts of the second carrier film and the first function layer body.

T600: heating the temperature to the bonding temperature to soften the second composite layer 02, bonding the upper bonding socket 410 to the second composite layer 02, and performing press-bonding treatment; and

T700: removing the bonding socket.

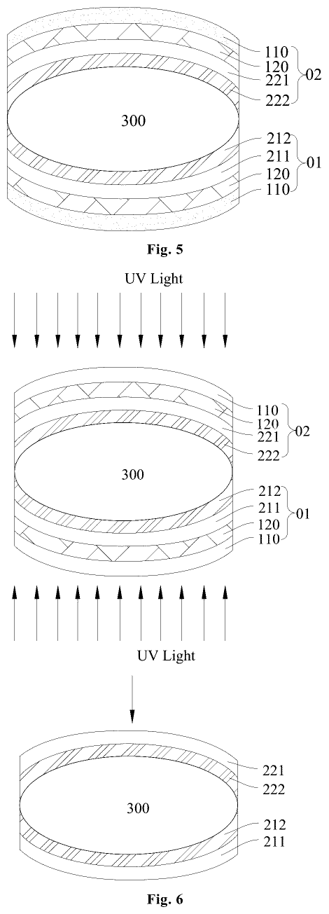

According to some embodiments of the present application, referring to FIG. 5, after completing the bonding of the second composite layer 02, the bonding method of the present application further includes: cutting the second composite layer body 02 according to the size of the lens to obtain the second composite layer body 02 matched with the size of the lens.

According to some embodiments of the present application, in the bonding process of the first composite layer 01 and the lens and that of the second composite layer 02 and the lens, the bonding temperature may be 100-130° C., for example, 100° C., 105° C., 110° C., 115° C., 120° C., 125° C., 130° C. and the like. At the above temperature, the first composite layer 01 and the second composite layer 02 may be softened so as to be bonded with the lens with a curved surface, and the above temperature does not have any adverse effect on each film layer in the first composite layer 01 and the second composite layer 02, nor on the lens. The bonding temperature of the first composite layer 01 and the lens and the bonding temperature of the second composite layer 02 and the lens can be the same or different, as long as they are within 100-130° C.

In some embodiments, the specific types of the first adhesive layer and the second adhesive layer may be optical adhesive (OCA) or pressure sensitive adhesive (PSA), and the optical transparency of the two adhesives is preferable.

According to some embodiments of the present application, referring to FIG. 6, after the first composite layer 01 and the second composite layer 02 are bonded, the adhesion-reducing adhesive layer 120 and the substrate 110 in the carrier film are removed, and the removing method includes the following steps:

E100: respectively carrying out UV light irradiation on the surface of the substrate 110 of the first carrier film and the surface of the substrate 110 of the second carrier film, so that the peeling force of the adhesion-reducing adhesive layer 120 of the first carrier film and the peeling force of the adhesion-reducing adhesive layer 120 of the second carrier film are reduced, and further the adhesive force between the adhesion-reducing adhesive layer and the optical function layer is reduced.

The intensity of UV light irradiation is not particularly limited, and those skilled in the art can flexibly adjust the irradiation intensity of UV light according to actual conditions such as the requirement for the magnitude of the peeling force of the adhesion-reducing adhesive layer 120 before adhesion-reducing and the peeling force thereof after the adhesion-reducing.

E200: peeling the adhesion-reducing adhesive layer 120 of the first carrier film from the substrate 110 thereof, and peeling the adhesion-reducing adhesive layer 120 of the second carrier film from the substrate 110 thereof, thereby obtaining a lens to which an optical function layer is bonded, that is, a folded optical path lens.

According to some embodiments of the present application, the first function layer body includes at least one of a wavelength phase retardation film (QWP, such as ¼ wavelength phase retardation film, ½ wavelength phase retardation film and the like), a reflective polarizing film (PR), and a linear polarizing film (LR), and the second function layer body includes at least one of the wavelength phase retardation film, the reflective polarizing film, and the linear polarizing film. Therefore, a person skilled in the art can flexibly select a specific optical function film layer in the optical function layers according to a specific application context and function of the lens.

Wherein, since the reflective polarizing film RP and the wavelength phase retardation film QWP each have respective optical axis directions, in order to secure that the lens with an optical function layer, i.e., folded optical path lenses, has good performance, it requires the optical axes of the QWP and the RP to assume a particular angle (e.g., 45 degrees, 135 degrees and the like). Therefore, before the RP is curved and bonded, the polarized laser provided by the machine passes through the carrier film, the reflective polarizing film RP, the adhesive layer, the lens, the adhesive layer and the wavelength phase retardation film QWP (the sequence can be reversed), and is finally received and analyzed by the receiver to obtain the real-time angles of the RP and the QWP. Finally, the lens is automatically rotated by the mechanical arm, so as to achieve a specific angle required by the RP and the QWP, and in this process, the carrier film of the present application has no influence on the optical path of polarized light, and further, the optical performance of the optical function layer cannot be influenced, and the good performance of the folded optical path lens is ensured.

According to the embodiment of the application, the bonding method has the advantages that the bonding precision is high, the process is simple, the implementation is easy; the industrial production is realized. The carrier film does not have interference on the optical path of the optical function layer bonded thereto, and does not influence the optical performance of the optical function layer. The carrier film has stable performance in thermal and mechanical aspects and can not be deteriorated, so that the composite layer can be well matched with the profile of the lens and well bonded with the lens at the bonding temperature, and the substrate and the adhesion-reducing adhesive layer will not cause corrosion and other undesirable phenomena to an optical function layer bonded thereto.

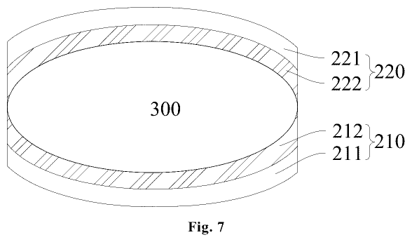

In yet another aspect of the present application, the present application provides a folded optical path lens. According to an embodiment of the present application, referring to FIG. 7, the folded optical path lens includes a lens 300 and optical function layers (including a first optical function layer 210 and a second optical function layer 220), wherein the optical function layers are bonded to the surfaces of the lens, and the bonding method is implemented by the bonding method described above. Therefore, the folded optical path lens has good optical performance and is not easy to generate practical problems such as stray light, ghost shadow and the like.

According to the embodiments of the present application, the folded optical path lens of the present application may further include, in addition to the above-mentioned lens and the optical function layer, structures or components necessary for a conventional folded optical path lens. For example, in some embodiments, the folded optical path lens of the present application further includes, in addition to the above-mentioned lens and the optical function layer, a semi-transmissive and semi-reflective film (BS) disposed on a side of the optical function layer facing away from the lens. For example, the optical function film layer includes a wavelength phase retardation film (QWP) and a reflective polarizing film (PR), and the semi-transmissive and semi-reflective film BS may be disposed on the side of the wavelength phase retardation film (QWP) facing away from the reflective polarizing film (PR).

The terms “first”, “second” and “first” are used herein for descriptive purposes only and are not to be construed as indicating or implying relative importance or to implicitly indicate the number of technical features indicated. Thus, a feature defined as “first” or “second” may explicitly or implicitly include one or more of that feature. In the description of the present application, “a plurality” means two or more unless specifically defined otherwise.

In the description of the specification, reference to the description of “one embodiment”, “some embodiments”, “an example”, “a specific example”, or “some examples” or the like means that a particular feature, structure, material, or characteristic described in connection with the embodiment or example is included in at least one embodiment or example of the application. In this specification, the schematic representations of the terms used above are not necessarily intended to refer to the same embodiment or example. Furthermore, the particular features, structures, materials, or characteristics described may be combined in any suitable manner in any one or more embodiments or examples. Moreover, various embodiments or examples and features of various embodiments or examples described in this specification can be combined and combined by one skilled in the art without being mutually inconsistent.

Although embodiments of the present application have been shown and described above, it will be understood that the above embodiments are exemplary and not to be construed as limiting the present application, and that changes, modifications, substitutions and alterations can be made to the above embodiments by those of ordinary skill in the art within the scope of the present application.

What is claimed is:

1. A carrier film, wherein
the carrier film comprises a substrate, an adhesion-reducing adhesive layer and a release protective film which are sequentially stacked,
wherein a light transmittance of a composite layer of the substrate and the adhesion-reducing adhesive layer is greater than or equal to 90%, the carrier film is bonded with a target optical structure at a bonding temperature, and the composite layer is softened at the bonding temperature.

2. The carrier film according to claim 1, wherein the substrate satisfies at least one of the following conditions:
a thickness of the substrate is 30-150 micrometers, and a deviation of the thicknesses at different positions is less than or equal to 5%;
a surface roughness Ra of the substrate is less than or equal to 0.5 micrometer; or
a surface tension of the substrate is greater than or equal to 50 mN/m.

3. The carrier film according to claim 2, wherein an elongation at break of the substrate is greater than or equal to 10% at the bonding temperature.

4. The carrier film according to claim 2, wherein the substrate further satisfies at least one of the following conditions:
a softening temperature of the substrate is greater than or equal to a preset temperature, and the preset temperature is the bonding temperature minus 30° C.; or
a shape and a color of the substrate do not change when the substrate is processed at the bonding temperature for a preset time.

5. The carrier film according to claim 2, wherein the substrate further satisfies at least one of the following conditions:
a light transmittance of the substrate is greater than or equal to 90%;
a haze of the substrate is less than or equal to 1%; or
an in-plane phase retardation RO of the substrate is less than or equal to 10 nm.

6. The carrier film according to claim 1, wherein the substrate comprises at least one of: Polymethyl Methacrylate, Polycarbonate, Triacetyl Cellulose, Cyclic Olefin Polymer, Cyclic Olefin Copolymer, Polyester, Polypropylene, Polyethylene, Polyolefin, Polyimide, Thermoplastic Polyurethane, or Polyvinyl Chloride.

7. The carrier film according to claim 1, wherein the adhesion-reducing adhesive layer satisfies at least one of the following conditions:
a thickness of the adhesion-reducing adhesive layer is 0.1-20 micrometers, and a deviation of the thicknesses at different positions is less than or equal to 5%;
the adhesion-reducing adhesive layer comprises at least one of acrylic adhesive, epoxy adhesive, organic silicon adhesive or polyurethane adhesive; or
a coating method for forming the adhesion-reducing adhesive layer comprises at least one of slot die coating, micro-gravure coating or comma coating.

8. The carrier film according to claim 7, wherein the adhesion-reducing adhesive layer further satisfies at least one of the following conditions:
a peeling force between the adhesion-reducing adhesive layer and an adhered film layer before adhesion-reducing is greater than or equal to 1000 gf/cm²; or
a peeling force between the adhesion-reducing adhesive layer and the adhered film layer after adhesion-reducing is less than or equal to 100 gf/cm².

9. The carrier film according to claim 7 wherein the adhesion-reducing adhesive layer is an ultraviolet (UV) adhesion-reducing adhesive layer, and the UV adhesion-reducing adhesive layer satisfies at least one of the following conditions:
a wavelength of an UV light is 365 nm-410 nm; or
a light intensity density received by an adhesive surface of the UV adhesion-reducing adhesive layer is greater than or equal to 2000 mJ/cm².

10. The carrier film according to claim 9, wherein the UV adhesion-reducing adhesive layer further satisfies at least one of the following conditions:
the UV adhesion-reducing adhesive layer has a tolerance time of not less than 3 minutes at the bonding temperature; or
when a thickness of the UV adhesion-reducing adhesive layer is 100 micrometers, a light transmittance of the UV adhesion-reducing adhesive layer is greater than or equal to 90%, and a haze of the UV adhesion-reducing adhesive layer is less than or equal to 1%.

11. The carrier film according to claim 1, wherein the release protective film satisfies at least one of the following conditions:
a thickness of the release protective film is 5-100 micrometers;
a surface roughness Ra of the release protective film is less than or equal to 0.5 micrometer;
a residual adhesion rate of the release protective film is greater than or equal to 90%; or
a peeling force between the release protective film and the adhesion-reducing adhesive layer is less than or equal to 200 gf/cm².

12. A bonding method, comprises:
providing a first carrier film, and removing a release protective film of the first carrier film, wherein the first carrier film comprises a substrate, an adhesion-reducing adhesive layer and the release protective film which are sequentially stacked, a light transmittance of a composite layer of the substrate and the adhesion-reducing adhesive layer of the first carrier film is greater than or equal to 90%, the carrier film of the first carrier film is bonded with a target optical structure at a bonding temperature, and the composite layer of the first carrier film is softened at the bonding temperature;
providing a first optical function layer, wherein the first optical function layer comprises a first function layer body and a first adhesive layer which are sequentially stacked;
adhering a surface of the adhesion-reducing adhesive layer of the first carrier film to a surface of the first function layer body facing away from the first adhesive layer to obtain a first composite layer body;
providing a lens and a bonding socket, wherein the bonding socket comprises an upper bonding socket and a lower bonding socket, a profile of the lens is respectively matched with a profile of a bonding surface of the upper bonding socket and a profile of a bonding surface of the lower bonding socket, and placing the lens on the bonding surface of the lower bonding socket;
placing the first composite layer body on a side of the lens facing away from the lower bonding socket, wherein the first adhesive layer is arranged close to the lens;
heating a temperature to the bonding temperature to soften the first composite layer body, bonding the upper bonding socket to the first composite layer body and performing pressing-bonding treatment; and removing the bonding socket.

13. The method according to claim 12, further comprising:
providing a second carrier film, and removing a release protective film of the second carrier film, wherein the second carrier film comprises a substrate, an adhesion-reducing adhesive layer and the release protective film which are sequentially stacked, a light transmittance of a composite layer of the substrate and the adhesion-reducing adhesive layer of the second carrier film is greater than or equal to 90%, the carrier film of the second carrier film is bonded with a target optical structure at a bonding temperature, and the composite layer of the second carrier film is softened at the bonding temperature;
providing a second optical function layer, wherein the second optical function layer comprises a second function layer body and a second adhesive layer which are sequentially stacked;
adhering a surface of the adhesion-reducing adhesive layer of the second carrier film to a surface of the second function layer body facing away from the second adhesive layer to obtain a second composite layer body;
placing the other surface of the lens on the bonding surface of the lower bonding socket, wherein the substrate of the first carrier film is in contact with the bonding surface of the lower bonding socket;
placing the second composite layer body on a side of the lens facing away from the lower bonding socket, wherein the second adhesive layer is arranged close to the lens;
heating a temperature to the bonding temperature to soften the second composite layer body, bonding the upper bonding socket to the second composite layer body, and performing press-bonding treatment; and
removing the bonding socket.

14. The method according to claim 13, wherein the adhesion-reducing adhesive layers of the first carrier film and the second carrier film is a UV (ultraviolet) adhesion-reducing adhesive layer, and the method further comprises:
respectively carrying out UV light irradiation on a surface of the substrate of the first carrier film and a surface of the substrate of the second carrier film, so that a peeling force of the adhesion-reducing adhesive layer of the first carrier film and a peeling force of the adhesion-reducing adhesive layer of the second carrier film is reduced; and
peeling the adhesion-reducing adhesive layer of the first carrier film from the substrate thereof, and peeling the adhesion-reducing adhesive layer of the second carrier film from the substrate thereof.

15. The method according to claim 13, wherein the first function layer body comprises at least one of a wavelength phase retardation film, a reflective polarizing film, or a linear polarizing film, and the second function layer body comprises at least one of the wavelength phase retardation film, the reflective polarizing film, or the linear polarizing film.

16. The method according to claim 12, wherein the bonding temperature is 100-130° C.

17. A folded optical path lens, comprises a lens and an optical function layer, wherein the optical function layer is bonded to a surface of the lens by a bonding method comprising:
providing a first carrier film, and removing a release protective film of the first carrier film, wherein the first carrier film comprises a substrate, an adhesion-reducing adhesive layer and the release protective film which are sequentially stacked, a light transmittance of a composite layer of the substrate and the adhesion-reducing adhesive layer is greater than or equal to 90%, the carrier film is bonded with a target optical structure at a bonding temperature, and the composite layer is softened at the bonding temperature;
providing the optical function layer, wherein the optical function layer comprises a first function layer body and a first adhesive layer which are sequentially stacked;
adhering a surface of the adhesion-reducing adhesive layer of the first carrier film to a surface of the first function layer body facing away from the first adhesive layer to obtain a first composite layer body;
providing the lens and a bonding socket, wherein the bonding socket comprises an upper bonding socket and a lower bonding socket, a profile of the lens is respectively matched with a profile of a bonding surface of the upper bonding socket and a profile of a bonding surface of the lower bonding socket, and placing the lens on the bonding surface of the lower bonding socket;
placing the first composite layer body on a side of the lens facing away from the lower bonding socket, wherein the first adhesive layer is arranged close to the lens;
heating a temperature to the bonding temperature to soften the first composite layer body, bonding the upper bonding socket to the first composite layer body and performing pressing-bonding treatment; and
removing the bonding socket.

18. A folded optical path lens, comprises a lens and an optical function layer, wherein the optical function layer is bonded to a surface of the lens by the bonding method according to claim 13.

19. A folded optical path lens, comprises a lens and an optical function layer, wherein the optical function layer is bonded to a surface of the lens by the bonding method according to claim 14.

20. A folded optical path lens, comprises a lens and an optical function layer, wherein the optical function layer is bonded to a surface of the lens by the bonding method according to claim 15.
